(19) United States
(12) Patent Application Publication
(10) Pub. No.: US 2019/0160986 A1
(43) Pub. Date: May 30, 2019

(54) Amplified Vehicular Circulation Device And Assembly Using The Same

(71) Applicant: Carl TSAI, Irvine, CA (US)

(72) Inventor: Carl TSAI, Irvine, CA (US)

(73) Assignee: Shenzhen China Star Optoelectronics Technology Co., Ltd., GRAND CAYMAN (KY)

(21) Appl. No.: 15/828,390

(22) Filed: Nov. 30, 2017

(51) Int. Cl. B60N 2/56; B60H 1/24; B60H 1/00; F04D 25/08

(52) U.S. Cl. CPC B60N 2/5628; B60N 2/5635; B60N 2/5657; B60H 1/247; A47C 7/744; B60H 1/00828; B60H 1/00207; F04D 25/08; B60H 1/241

(57) ABSTRACT

A climate pad assembly is coupled with the amplified vehicular circulation device so as to draw and redirect the airflow immediately from a vent of the vehicular air condition into a climate pad seated on the car seat such that the climate pad be consistently and efficiently circulated with conditioned airflow from an output vent of a vehicle so as to provide a comfortable environment of the baby car seat.

### FIELD OF THE INVENTION

The present invention relates to a vehicular circulation device, and more particularly to an amplified or forced air circulation device intended to provide conditioned airflow to everywhere within the compartment of the vehicle such that that the heated or cooled airflow from the car's heating, ventilation, and air conditioning (HVAC) system can reach thereto normally.

### DESCRIPTION OF PRIOR ART

The compartment of a vehicle is a confined area without any air circulation or exchange when windows are closed. Typically, there are four vents on the dashboard, two are located in central, and the other two are located in driver's and passenger's sides, respectively. However, there are only two vents are located in the rear wall of the central console which provides limited climate control to the passengers sit in the rear seat. When the engine starts, and the air condition is running, the front half of the compartment is always cooler than the rear half as the airflow in the front are cooler and stronger. Typically, when a vehicle parks under the sun, even the ambient temperature is around 80 degrees Fahrenheit, the temperature inside the compartment of the vehicle can easily rise above 100 degrees Fahrenheit, or even 120 degrees Fahrenheit!

Nevertheless, the car seats for baby or toddler are required to be installed at the rear seat by law. Even when the vehicle is started and the air condition is on to cool down the temperature, the baby seat is still like a hot-pan as the heat built-up thereof has no possibility of dissipating into the ambient environment. Even with the air conditioning on at full blast, baby's back may still be drenched with sweat as the baby car seat is like a baking pan. During winter, it will become frigid cold.

In order to provide the car seats a comfortable sitting environment, many innovations and efforts have been put into actions, there are still a demand to effectively resolve this issue. One typical device is a cooling pad with a cooling fan installed so as to create a forced circulation along the pad. The cooling fan draws in the ambient air or cooled air within the compartment, and then circulate the cooled air into the cooling pad in an attempt to lower the temperature of the car seat.

US Pat. Pub. 20120322355 A1 submitted by Paquin provides climate regulation system. According to the disclosure, the system is intended for extending and directing the flow of air-conditioning or heat within a vehicle by way of providing a connector and a detachable extension operable with a preexisting vehicle climate regulation system.

U.S. Pat. No. 6,884,159 B1 issued to Ferraud discloses a hose assembly intended for directing conditioned air from an air outlet vent of a vehicle's air conditioning system to various locations within the vehicle.

U.S. Pat. No. 6,843,717 B1 issued to Bennett discloses a vent extender working like a garden hose for directing airflow from a certain vent to an intended area, as shown in FIG. 1, to the facial area.

U.S. Pat. No. 4,981,324 A issued to Law discloses a Ventilated back-seat support pad particularly for vehicles. According to its disclosure, a ventilated back support pad is configured and suitable to be seated atop an automobile seat. The pad is provided with a plurality of apertures on one or more of its faces, and forced air is channeled from a selected automotive air vent through the apertures via a flexible hose having one end connected with air passageways within the support pad.

It can be readily appreciated that none of the prior arts discussed above provides a consistent and efficient method for cooling heat-pan problem. The same applies to winter condition as well.

### SUMMARY OF THE INVENTION

It is the object of the present invention to provide an amplified or forced air circulation connector through which the conditioned airflow from the HVAC system can be properly and efficiently directed to the intended area.

In order to attain the intended purposes of the present invention, a typical embodiment made in accordance with the present invention, a climate pad assembly is coupled with the amplified vehicular circulation device so as to draw and redirect the airflow immediately from a vent of the vehicular air condition into a climate pad seated on the car seat such that the climate pad be consistently and efficiently circulated with conditioned airflow from an output vent of a vehicle so as to provide a confortable environment of the baby car seat.

In order to achieve to the intended purpose, according to another one of a preferable embodiments made in accordance with the present invention, a climate pad assembly is provided and it comprises a climate pad including a back portion, a seat portion, and a skirt portion coupling to the seat portion. An inlet vent is arranged at the seat portion, and an internal circulating conduit system is arranged therein and in communication with the inlet vent. The climate pad assembly is further coupled to the amplified vehicular ventilation device which preferably includes a blower box having a blower installed therein, and includes at least an inlet and an outlet. An extension tube is attached to the outlet, and having an connector capable of being coupled to the inlet located at the skirt portion of the climate pad.

It is believed that with the provision of the amplified vehicular ventilation device, every corner of the compartment of a vehicle can be reached with conditioned airflow so as to provide an amicable environment beneficial to everyone sits therein.

### BRIEF DESCRIPTION OF DRAWINGS

The solution, as well as other beneficial advantages, of the present invention will be apparent from the following detailed description of embodiments of the present invention, with reference to the attached drawing. In the drawing:

FIG. 1 is an illustration view showing the use of a climate pad along with an extension tube, and a car vent;

FIG. 1A is an illustrational view showing a mounting bracket attached to a car vent;

FIG. 2 is an illustration view of an amplified vehicular ventilation device;

FIGS. 3a, 3b, and 3c are also an illustration view of the climate pad of FIG. 1 in use with the amplified vehicular ventilation device shown in FIG. 2; and

FIG. 4 is an illustration showing other implementations of the amplified vehicular ventilation device shown in FIG. 2.

### DETAILED DESCRIPTION OF PREFERRED EMBODIMENTS

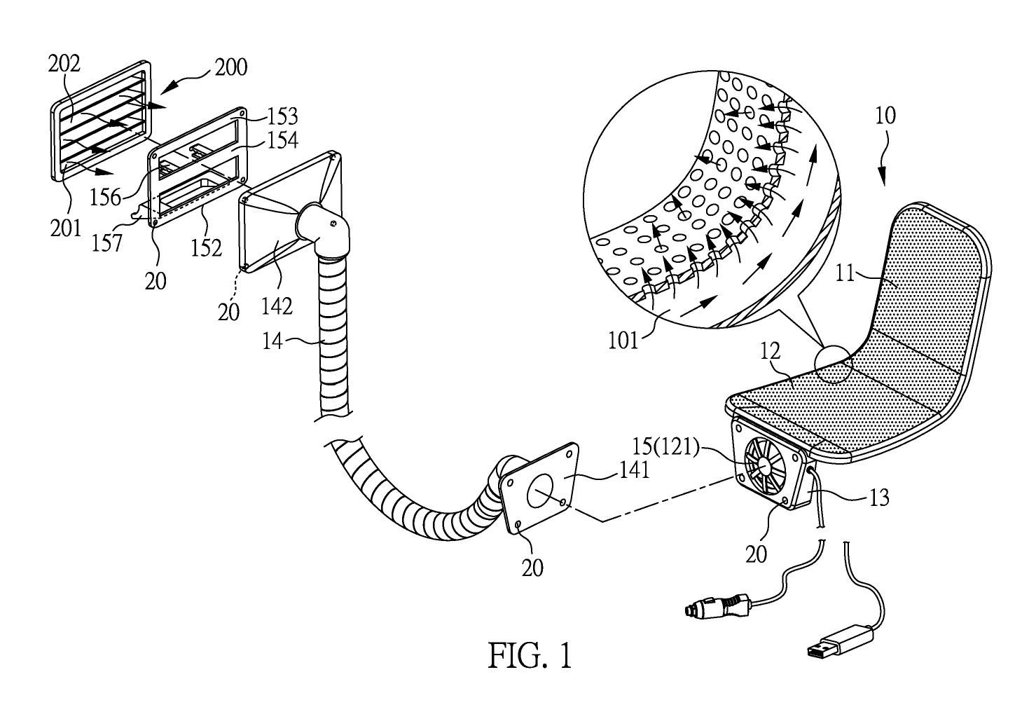

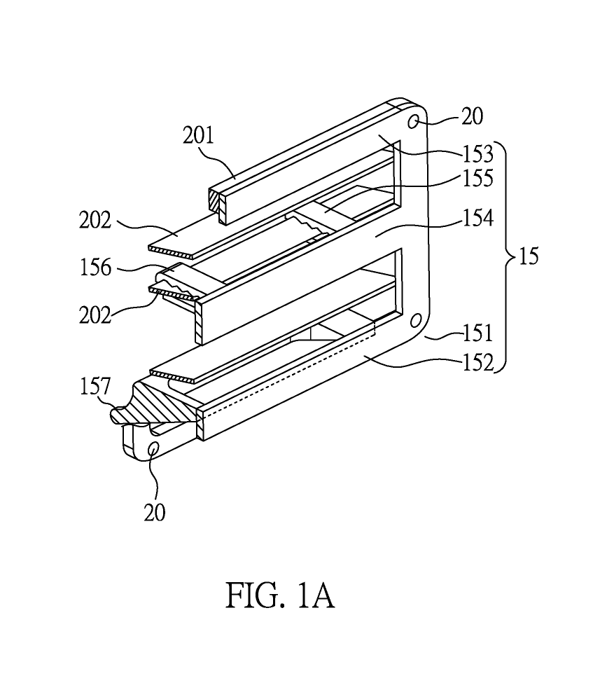

Referring to FIG. 1, a climate pad assembly 1 made according to the present invention includes a climate pad 10 configured with a back portion 11, a seat portion 12, and a skirt portion 13 coupling to the seat portion 12, an inlet vent 121 is arranged at the seat portion 12.

Internal circulating conduits 101 are arranged in the back portion 11 and the seat portion 12 and being in communication with the inlet vent 121.

The assembly 1 further includes an interconnecting tube 14 having a first connector 141 detachably attached to the inlet vent 121 of the seat potion 12, and a second connector 142 capable of being detachably attached to an air conditioner port 201 of a car's heating, ventilation, and air conditioning (HVAC) system 200. The interconnecting tube 14 can be made with a bellow tube or corrugated tube making it more flexible in adjusting its length in use.

Referring to FIG. 1A, a mounting bracket 15 is used to provide an attachment for the second connector 142. According to the preferable embodiment, the mounting bracket 15 includes a frame 151, having an upper and lower bars 152 and 153. A central bar 154 is also arranged between the upper and lower bars 152 and 153. At least a pair of hooks 155 and 156 are arranged at the central bar for attaching to a fin 202 of the air conditioner port 201. The mounting bracket 15 further includes an anchor 157 which can readily rest onto the lower edge of air conditional port 201.

With the provisions of the hooks 155, 156 and the anchor 157, the mounting bracket 15 can be readily attached to the air conditioner port 201 by the engagement between the hooks 155, 156 and the fin 202 of the air conditioner port 201.

The mounting bracket 15 is provided with magnetic devices 20 such that it provides convenient, but safe interconnections. The magnetic devices 20 provide non-destructive interconnection for safe and convenient interconnection.

It can be readily appreciated that when the climate pad assembly 1 is coupled with the HVAC system 200, cooled or heated air can be forced to circulate inside the climate pad assembly 1. As a result, the temperature of the climate pad assembly can be cooled or heated properly and provide a proper sitting environment during summer or winter.

According to one of the preferred embodiment, a blower 16 is arranged at the inlet vent 121 so as to boost the circulation within the climate pad assembly 1.

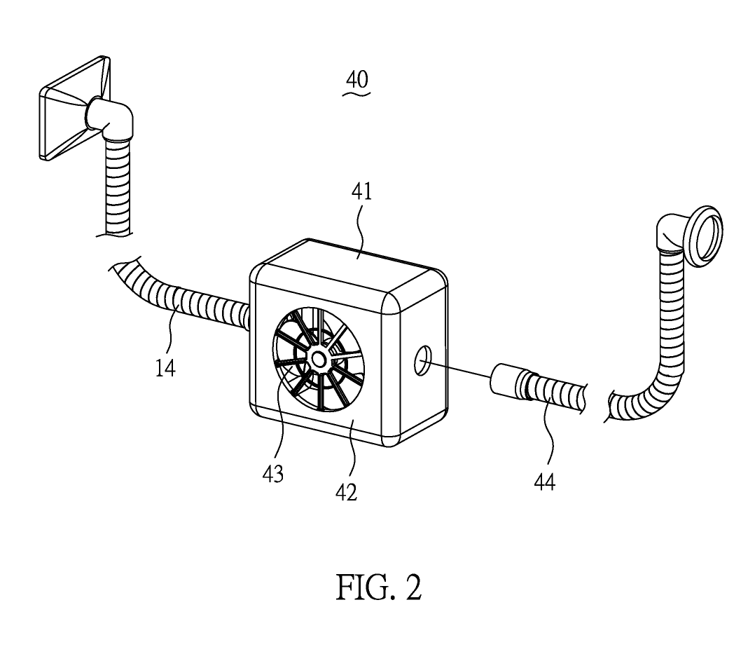

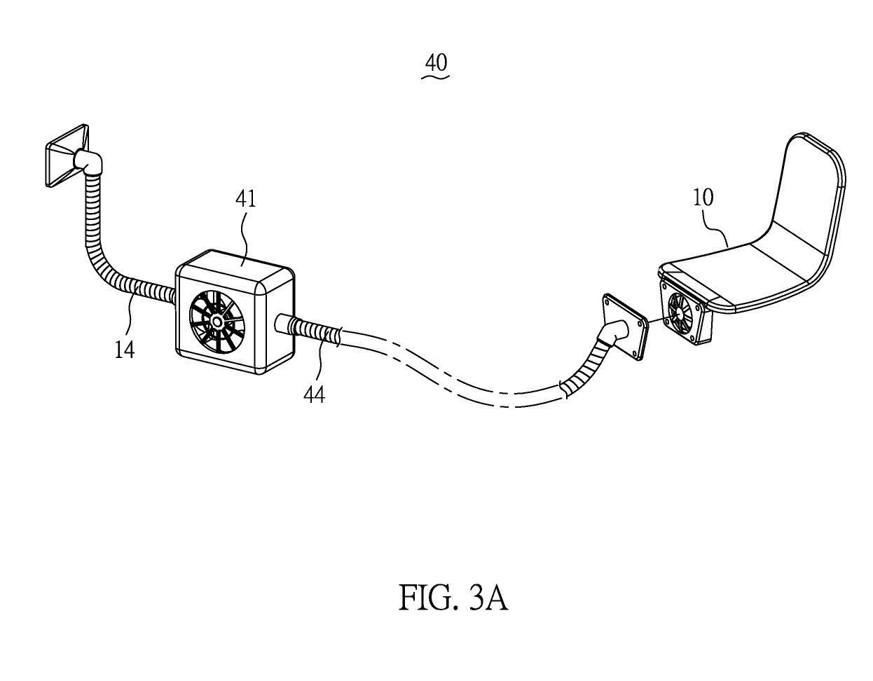

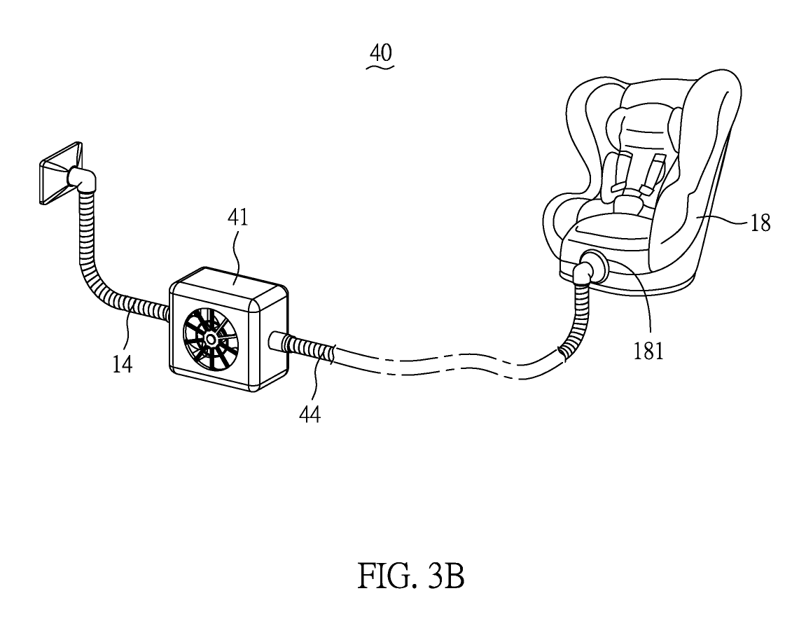

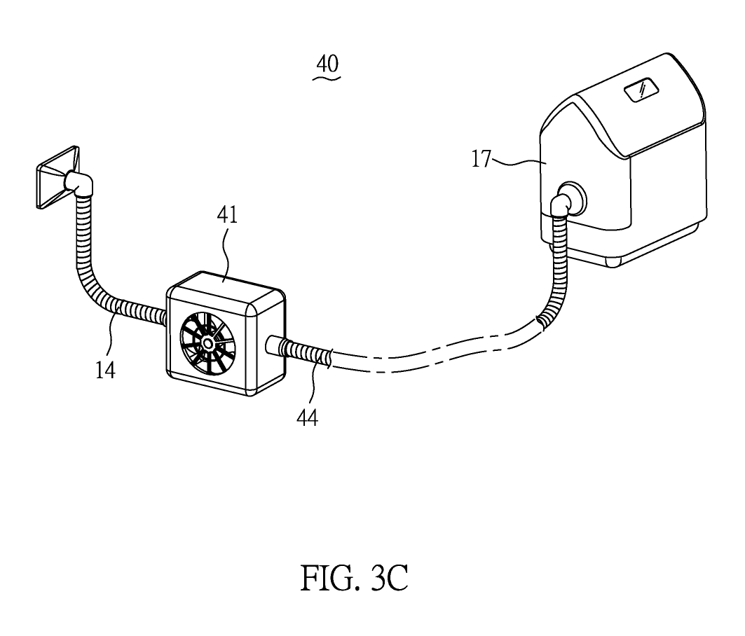

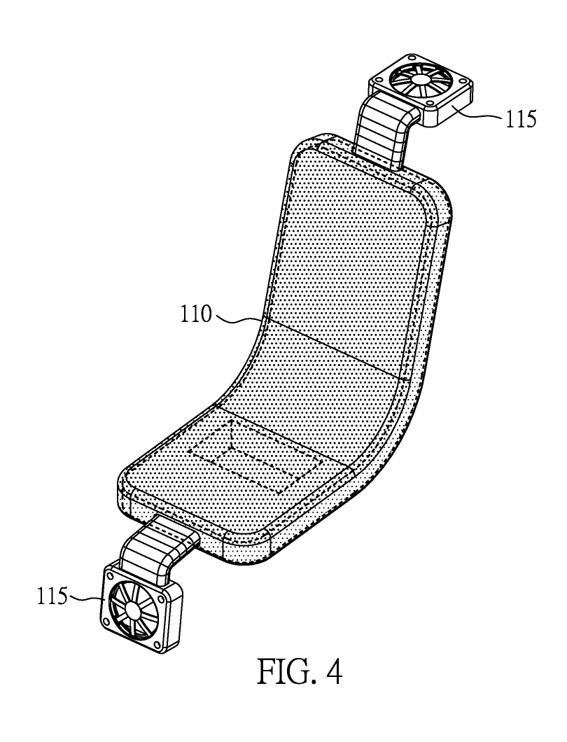

According to another embodiment of the present invention, as shown in FIG. 2, wherein the interconnecting tube 14 be connected to a fan box 42 in which a second blower 43 is installed. It can be readily appreciated that with the provision of the fan box 42, the interconnecting tube 14 can be used in a lot of different situations for different utilizations, such as shown in FIG. 3, for example, an ice box 17 can be connected to the interconnecting tube 14 so as to prolong the cooling or heating efficiency of the ice box 17, such as shown in FIG. 3c.

In addition, in case a car seat 18 is incorporated with internal circulation system such as disclosed in the climate pad assembly 1, then the interconnecting tube 14 along with its fan box 141 can be used to supply cooled or heat air to the car seat 18.

According to one of the embodiment, wherein the first connector 141 is detachably attached to the inlet vent 121 by the magnetic device 20, such as a button magnet. The magnetic devices 20 can be attached to the first connector 141.

According to another preferred embodiment of the present invention, wherein the second connector is also incorporated with the magnetic device 20. Since the magnetic coupling can be readily separated, and thereby providing more convenience to the user. The magnetic devices 20 can be replaced to other adequate arrangements, such a Velcro strap or other suitable arrangements.

While the shape of the first and second connectors 141, 142 can be any appropriate shape, it is preferably to have a rectangular shape so as to properly match with the port 201 of the HVAC system 200.

Referring to FIG. 2, an amplified vehicular ventilation device 40 is shown, and it is an variant of the interconnecting tube 14 of FIG. 1. The amplified vehicular ventilation device 40 includes fan box 41 having a cubic container 42 in which a blower or fan 43 is installed. The ventilation device 40 also includes a tube 44 to direct the air to the intended area. With this blower 43 to forcibly circulate the air, either the climate pad assembly 10, FIG. 3a, or the ice box 17, FIG. 3c, can be efficiently and quickly cooled down.

Even the climate pad assembly 1 is described and introduced as a separate element of a car seat 18 available to the market, however, it can be readily appreciated by the skilled in the art that the climate pas assembly 1 can be integrally formed with the car seat 18, and the amplified vehicular ventilation device 40 can be readily used to supply cooled or heated air to the climate pad assembly 1 integrally formed with the car seat 18, such as shown in FIG. 3b. It can be appreciated that an inlet 181 can be readily arranged at a proper position of the car seat 18 such that the tube 44 of the vehicular device 40 can be readily plugged in to achieve its intended purpose.

According to one of the preferred embodiment, a layer of non-skid raised dots 17 is arranged on top of the climate pad assembly 1 so as to provide a firm grip to the toddler.

With the forced circulations of airflow created by the fan box, the pad assembly 1 can be efficiently and quickly cooled down as the fan box is in speeding up the pulling of air from the ac vent, thereby benefiting a pleasant and intended results.

Based on the description given above, those having ordinary skills of the art may easily contemplate various changes and modifications of the technical solution and technical ideas of the present invention and all these changes and modifications are considered within the protection scope of right for the present invention.

1. A climate pad assembly, comprising:
a climate pad including a back portion, a seat portion, and a skirt portion coupling to the seat portion, an inlet vent being arranged at the seat portion;
internal circulating conduits arranged in the back portion and the seat portion and being in communication with the inlet vent; and
an interconnecting tube having a first connector detachably attached to the inlet vent of the seat potion, and a second connector capable of being detachably attached to an air conditioner port.

2. The climate pad assembly as recited in claim 1, wherein a blower is arranged at the inlet vent.

3. The climate pad assembly as recited in claim 1, wherein the interconnecting tube is arranged with a second blower.

4. The climate pad assembly as recited in claim 1, wherein the first connector is detachably attached to the inlet vent by magnetic device.

5. The climate pad assembly as recited in claim 1, wherein the second connector is also incorporated with magnetic device.

6. The climate pad assembly as recited in claim 4, wherein the first connector has a rectangular shape.

7. The climate pad assembly as recited in claim 5, wherein the second connector has a rectangular shape.

8. A climate pad assembly, comprising:
a climate pad including a back portion, a seat portion, and a skirt portion coupling to the seat portion, an inlet vent being arranged at the seat portion;
a blower box having a blower installed therein, and including at least an inlet and an outlet; and
an extension tube attached to the outlet of the blower box, and having an connector capable of being coupled to the inlet of a climate pad.

9. The climate pad assembly as recited in claim 8, wherein an internal circulating conduits are arranged in the back portion and the seat portion and is in communication with the inlet vent.

10. The climate pad assembly as recited in claim 8, wherein the first connector is detachably attached to the inlet vent by magnetic device.

11. The climate pad assembly as recited in claim 8, wherein the second connector is also incorporated with magnetic device.

12. The climate pad assembly as recited in claim 10, wherein the first connector has a rectangular shape.

13. The climate pad assembly as recited in claim 11, wherein the second connector has a rectangular shape.

14. A climate pad assembly, comprising:
a climate pad including a back portion, a seat portion, and a skirt portion coupling to the seat portion, an inlet vent being arranged at the seat portion, an internal circulating conduits therein and being in communication with the inlet vent;
an interconnecting tube having a first connector detachably attached to the inlet vent of the seat potion, and a second connector capable of being detachably attached to an air conditioner port; and
a blower arranged in one of the inlet vent and the first connector.

15. The climate pad assembly as recited in claim 14, wherein the climate pad includes a layer of non-skid raised dots.

16. The climate pad assembly as recited in claim 14, wherein the interconnecting tube is made with a bellow or corrugated configuration so as to make it more flexible in length in use.

17. The climate pad assembly as recited in claim 14, wherein a mounting bracket is provided to assist a coupling between the second connector and the air conditioner port.

18. The climate pad assembly as recited in claim 17, wherein the mounting bracket includes a frame with a central bar, at least one hook is arranged on the central bar, and an anchor extending from a lower portion of the frame.
